(19) United States
(12) Patent Application Publication
(10) Pub. No.: US 2024/0248972 A1
(43) Pub. Date: Jul. 25, 2024

(54) SYSTEM AND METHODS FOR USER AUTHENTICATION USING CONTINUOUS FACIAL RECOGNITION

(71) Applicant: OPTUM, INC., Minnetonka, MN (US)

(72) Inventors: Tara Lynnmarie Long, Poolville, TX (US); Aaron Daniel Howard, Fort Worth, TX (US); John Foss, Colorado Springs, CO (US); Marc Edward Allgood, Eagle, ID (US); Madison Rose Shultz, Hermitage, TN (US); Stephanie Evette Mitchell, Canton, GA (US)

(21) Appl. No.: 18/159,297

(22) Filed: Jan. 25, 2023

(51) Int. Cl. G06F 21/32; G06F 21/62; G06V 40/16

(52) U.S. Cl. CPC G06F 21/32; G06F 21/6245; G06V 40/172; G06F 2221/2141

(57) ABSTRACT

A method of user authentication for a computer system includes continuously or periodically: obtaining at least one image of a field-of-view (FOV) of a depth-sensing image capture device directed outward from a user interface of the computer system, analyzing the at least one image using a facial recognition model with depth-sensing to determine whether a person is positioned within the FOV and, if it is determined that a person is positioned within the FOV, to determine whether the person is a registered user of the computer system. If it is determined that the person is a registered user of the computer system, then further determining permissions within the computer system for the person based on a user profile for the person and providing access to the computing system in accordance with the determined permissions.

### BACKGROUND

User authentication is a process or method by which the identity of a user of a computing resource (e.g., a computer system, a device, software, etc.) is verified to provide the user with access to the computing resource. In some cases, user authentication includes determining permissions for the user with respect to the computing resource, which may define and/or limit the content of the computing resource that the user can access, view, manipulate, etc. Commonly used user authentication methods, such as passwords or biometrics, can be relatively simple to implement but are not particularly robust. For example, passwords may be easily stolen or hacked. Fingerprint scanning is a common user authentication method for smartphones and personal computers but can be inaccurate and ineffective due to, for example, moisture, lotions, oils, sweat, etc., and fingerprint strength/quality is known to deteriorate over time as the body ages. Additionally, common user authentication techniques operate on the often incorrect assumption that once a user is logged in to a computing resource, they remain the only user until they either log out or a period of inactivity is detected.

Facial recognition, which generally refers to detecting and/or identifying a person using an image of their face, is an increasingly popular method of user authentication. Often, facial recognition can be faster and more user-friendly than other user authentication techniques, requiring little to no user input. However, current facial recognition techniques are also subject to numerous limitations. As with other common user authentication techniques, facial recognition based authentication generally happens only once and/or is time-released. For example, a user may only be identified at the start of an interaction with a computing resource and the user may remain authenticated or “logged in” until the interaction is complete or the authentication times out. Any lag in authentication (e.g., imposed by one-time only approach or time-based approach) poses a cybersecurity risk. Additionally, many traditional facial recognition approaches cannot differentiate between a real person and a photograph, which poses a risk to effectiveness as a system could be “spoofed” with a printed photo, mask, or the like.

### SUMMARY

One implementation of the present disclosure is a method of user authentication for a computer system. The method includes continuously or periodically: obtaining at least one image of a field-of-view (FOV) of a depth-sensing image capture device, analyzing the at least one image using a facial recognition model with depth-sensing to determine whether a person is positioned within the FOV and, if it is determined that a person is positioned within the FOV, to determine whether the person is a registered user of the computer system. If it is determined that the person is a registered user of the computer system, then further determining permissions within the computer system for the person based on a user profile for the person and providing access to the computing system in accordance with the determined permissions. Generally, the FOV of the image capture device is directed outward from a user interface of the computer system. Permissions generally define content that can be displayed via the user interface of the computer system.

Another implementation of the present disclosure is a non-transitory computer readable medium having instructions stored thereon that, when executed by at least one processor, cause a computing device to continuously or periodically: obtain at least one image of a FOV of a depth-sensing image capture device, analyze the at least one image using a facial recognition model to determine whether a person is positioned within the FOV and, if it is determined that a person is positioned within the FOV, determine whether the person is a registered user of the computing device. If it is determined that the person is a registered user of the computing device, then further determine permissions within the computing device for the person based on a user profile for the person and provide access to the computing device in accordance with the determined permissions. Generally, the FOV of the image capture device is directed outward from a user interface of the computer system. Permissions generally define content that can be displayed via the user interface of the computer system.

Yet another implementation of the present disclosure is a pharmacy computer system that includes a processor and memory having instructions stored thereon that, when executed by the processor, cause the pharmacy computer system to continuously or periodically: obtain at least one image of a FOV of a depth-sensing image capture device, analyze the at least one image using a facial recognition model to determine whether a person is positioned within the FOV and, if it is determined that a person is positioned within the FOV, determine whether the person is a registered user of the pharmacy computer system. If it is determined that the person is a registered user of the pharmacy computer system, then further determine permissions within the pharmacy computer system for the person based on a user profile for the person and provide access to the pharmacy computing system in accordance with the determined permissions. Generally, the FOV of the image capture device is directed outward from a user interface of the computer system. Permissions generally define content that can be displayed via the user interface of the computer system.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a diagram of an example computer system that uses depth-sensing facial recognition for user authentication, according to some implementations.

FIG. 2 is a flow chart of a process for user authentication using depth-sensing facial recognition, according to some implementations.

FIG. 3 is a flow chart of a process for modifying user permissions in a computer system if one or more additional persons are detected within a field-of-view (FOV) of a depth-sensing image capture device, according to some implementations.

FIG. 4 is a flow chart of a process for modifying user permissions in a computer system if it is determined that the user has stepped away from the computer system, according to some implementations.

FIGS. 5 and 6 are example user interfaces of a pharmacy management system while a user with sufficient permissions is within the FOV of a depth-sensing image capture device and when the user steps out of the FOV, respectively, according to some implementations.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, a system and methods for user authentication using facial recognition with depth sensing are shown, according to various implementations. At a high level, a user authentication technique is described herein which utilizes depth-sensing facial recognition to continuously or periodically identify, authenticate, and assign permissions to users of a computing resource. A “computing resource”, as described herein, may refer to a computing device, a computer system, and/or certain software applications executed on a computing device. The disclosed user authentication technique generally includes continuously or periodically (e.g., every five seconds) obtaining an image of a person's face within a field-of-view (FOV) of a depth-sensing image capture device (e.g., a depth-sensing camera), verifying that the detected person is an authorized user of the computing resource being secured, and generating or determining permissions within the computing resource if it is determined that the person is an authorized user. By continuously or periodically identifying, authenticating, and assigning permissions, access to a computing resource can be limited (e.g., the computing resource can be locked) when a user steps away from the device or when a new user is detected. In other words, user permissions within a computing resource can be quickly adjusted to prevent unauthorized users from accessing, viewing, and/or manipulating restricted information.

Consider, for example, a pharmacy setting. It is well known that pharmacies are a dynamic workplace, often having numerous employees (e.g., pharmacists, technicians, interns, assistants, etc.) each interacting with a pharmacy management system that manages patient information, prescription dispensing, billing and payments, and more. Pharmacy computing systems (e.g., workstations) that implement a pharmacy management system thus maintain, or have access to, large amounts of sensitive patient data (e.g., personal identifying information (PII), protected health information (PHI), etc.), which is subject to federal standards for data privacy and security (e.g., Health Insurance Portability and Accountability Act (HIPAA)). Accordingly, the various persons that work in a pharmacy generally have different permissions within a pharmacy management system. For example, pharmacy assistants and interns may be restricted from accessing patient information but may enter payment and/or insurance information. Pharmacy technicians may enter prescription and/or patient information but may not be allowed to complete steps such as verifying drug interactions and prescriptions, completing a medication view, etc., which must be completed by a pharmacist.

To these points, the continuous or periodic depth-sensing facial recognition technique described herein may be particularly useful in pharmacies and other dynamic environments, where multiple users have access to a computer system or one or more computing devices. In a pharmacy setting, continuously or periodically (e.g., every few seconds, every minute, etc.) verifying that a user is a registered or authorized user helps to ensure that unauthorized persons cannot access or view PII and PHI. If a user (e.g., a pharmacist) steps away from a workstation, for example, the workstation can be quickly or immediately locked to prevent unauthorized access. Further, in some implementations, the disclosed depth-sensing facial recognition technique allows for rapidly switching between users via facial recognition. For example, the depth-sensing facial recognition technique can be used to detect that a first user has stepped away from a workstation and that a second user has taken control of the workstation and can quickly adjust user permissions to those associated with the second user. In some implementations, the first user's work is retained for future access.

Depth-sensing, as mentioned above, generally refers to the use of depth sensors, or depth-sensing imaging devices, to acquire multi-point distance information across a FOV of the device. In more general terms, depth-sensing devices can be used to capture 3-dimensional (3D) information over a FOV. With respect to facial recognition, depth-sensing can be used to ensure that 2D images (e.g., photographs) cannot be used to access a computing resource. Depth-sensing therefore adds an additional layer of security over traditional facial recognition techniques through the use depth-sensing imaging devices to prevent unauthorized access to a computing resource through the use of 2D images, videos, etc. In some cases, depth-sensing can also be used to detect the use of masks, prosthetics, and the like. Additional features and details of the aforementioned depth-sensing facial recognition technique are described in greater detail below.

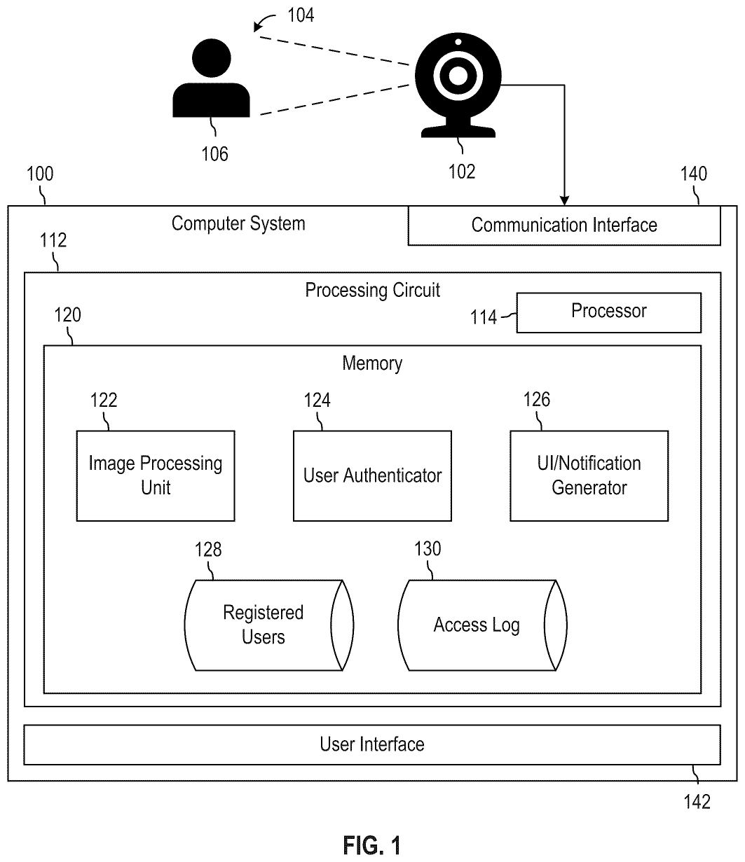

Referring now to FIG. 1, a diagram of an example computer system 100 that uses depth-sensing facial recognition for user authentication is shown, according to some implementations. While it should be appreciated that system 100 can generally be any computing system or device, such as a laptop, a desktop computer, a workstation, a server, a smartphone, etc., in some implementations, system 100 is an example pharmacy computing system. For example, system 100 may be a workstation or server within a pharmacy which implements pharmacy management software.

Communicably coupled to system 100 through a communications interface 140, which is described in greater detail below, is a depth-sensing image capture device 102 (also referred to as a “depth-sensing camera”). Generally, depth-sensing image capture device 102 is an image capture device (e.g., a camera) that is capable of determining a distance to one or more points on an object within its FOV. In various implementations, depth-sensing image capture device 102 is one of a stereo vision camera, a time-of-flight (ToF) camera, or a structured light camera. A stereo vision camera generally includes at least two image sensors that capture two or more images of a FOV (e.g., “stereo images”). A ToF camera generally measures the transit time of light reflected off of an object within the FOV. A structured light camera generally illuminates an object within the FOV with a pattern and subsequently measures distortions in the pattern.

In some implementations, depth-sensing image capture device 102 includes one or more sensors for depth-sensing along with a visible light camera (e.g., a camera that captures “standard” color images). For example, a ToF camera may include a visible light camera, at least one laser or LED for projecting light onto a subject, and at least one sensor for detecting reflected light. In another example, a stereo vision camera may include two or more visible light cameras for capturing images from different angles. Accordingly, in various implementations, depth-sensing image capture device 102 may include one or more infrared (IR) sensors and detector, lasers, LEDs, visible light cameras, etc. However, it should be appreciated that depth-sensing image capture device 102 is not limited to only the example depth-sensing cameras described above; rather, other suitable types of depth-sensing image capture devices are contemplated herein.

As mentioned briefly above, depth-sensing image capture device 102 generally defines a FOV 104 which is typically directed towards a user 106 of system 100. In some implementations, depth-sensing image capture device 102 is pointed outwards from a user interface 142 of system 100, which is described in greater detail below. In some implementations, user interface 142 includes a screen (e.g., user interface 142 is a computer monitor) and depth-sensing image capture device 102 may be positioned on top of the screen, directed outward towards a user (e.g., similar to a webcam). In some implementations, depth-sensing image capture device 102 is embedded into a display screen of system 100 or is positioned in another suitable location for capturing images of users of system 100. More simply, the FOV 104 of depth-sensing image capture device 102 is generally directed outward from user interface 142 and towards users of system 100.

System 100 is shown to include a processing circuit 112 that includes a processor 114 and a memory 120. Processor 114 can be a general-purpose processor, an application specific integrated circuit (ASIC), one or more field programmable gate arrays (FPGAs), a group of processing components, or other suitable electronic processing structures. In some embodiments, processor 114 is configured to execute program code stored on memory 120 to cause system 100 to perform one or more operations, as described below in greater detail. It will be appreciated that, in embodiments where system 100 is part of another computing device (e.g., a server) or is hosted on another device (e.g., a cloud server), the components of system 100 may be shared with, or the same as, the host device. For example, if system 100 is implemented via a cloud server, then system 100 may utilize the processing circuit, processor(s), and/or memory of the cloud server to perform the functions described herein.

Memory 120 can include one or more devices (e.g., memory units, memory devices, storage devices, etc.) for storing data and/or computer code for completing and/or facilitating the various processes described in the present disclosure. In some embodiments, memory 120 includes tangible (e.g., non-transitory), computer-readable media that stores code or instructions executable by processor 114. Tangible, computer-readable media refers to any physical media that is capable of providing data that causes system 100 to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory 120 can include random access memory (RAM), read-only memory (ROM), hard drive storage, temporary storage, non-volatile memory, flash memory, optical memory, or any other suitable memory for storing software objects and/or computer instructions. Memory 120 can include database components, object code components, script components, or any other type of information structure for supporting the various activities and information structures described in the present disclosure. Memory 120 can be communicably connected to processor 114, such as via processing circuit 112, and can include computer code for executing (e.g., by processor 114) one or more processes described herein.

While shown as individual components, it will be appreciated that processor 114 and/or memory 120 can be implemented using a variety of different types and quantities of processors and memory. For example, processor 114 may represent a single processing device or multiple processing devices. Similarly, memory 120 may represent a single memory device or multiple memory devices. Additionally, in some embodiments, system 100 may be implemented within a single computing device (e.g., one server, one housing, etc.). In other embodiments, system 100 may be distributed across multiple servers or computers (e.g., that can exist in distributed locations). For example, system 100 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers.

Memory 120 is shown to include an image processing unit 122 which processes image data captured by depth-sensing image capture device 102 for facial recognition. As mentioned above, depth-sensing image capture device 102 may be one of a stereo vision camera, a ToF camera, a structured light camera, or other suitable depth-sensing device, and thus may capture multiple types of data. For example, depth-sensing image capture device 102 may capture both visible light (e.g., RGB) images and IR images of FOV 104. Accordingly, “image data”, as referenced herein, may refer to any data captured by depth-sensing image capture device 102 to be used for one or both of facial recognition and depth-sensing. In some implementations, depth-sensing image capture device 102 itself is configured to process image data for depth-sensing and therefor transmits preprocessed depth data to image processing unit 122 (e.g., along with RGB or visible light images). For example, depth-sensing image capture device 102 may include an internal processing circuit that generates a depth map from captured image data such that the generated depth map is transmitted to image processing unit 122 for further processing. In other implementations, image processing unit 122 is configured to process all forms of image data captured by depth-sensing image capture device 102 and thereby executes a depth-sensing algorithm itself, as discussed below.

In some implementations, image processing unit 122 is configured to obtain image data from depth-sensing image capture device 102 either continuously or periodically. In some such implementations, for example, depth-sensing image capture device 102 records video of FOV 104, from which image processing unit 122 extracts still-frame images or which image processing unit 122 continuously analyzes. In other implementations, depth-sensing image capture device 102 periodically captures images of FOV 104 and transmits the captured image data to image processing unit 122. In some such implementations, image data is obtained at an interval of less than five seconds, although it will be appreciated that system 100 may be customized to obtain image date and authenticate users at any interval under a threshold of about one minute. For example, image processing unit 122 may obtain image data every second, every minute, multiple times within a second, etc. In some implementations, image processing unit 122 commands depth-sensing image capture device 102 to capture images (e.g., periodically). In some implementations, depth-sensing image capture device 102 continuously captures image data which is periodically analyzed by image processing unit 122.

As described herein, image processing unit 122 is generally configured to execute a facial recognition algorithm which detects faces within the obtained image data, generates a model of any detected faces and/or calculates identifying characteristics of any detected faces, and compares the model and/or identifying characteristics to a database of registered users 128 to determine whether any detected persons are authorized users of system 100. Generally, image processing unit 122 may use any suitable facial recognition algorithm, or model, to analyze the image data in this manner. For example, image processing unit 122 may include a neural network (e.g., a convolution neural network (CNN)) that is trained for facial recognition. Other facial recognition algorithms can include eigenfaces, fisherfaces, principal component analysis (PCA), a support vector machine (SVM), and the like. It should therefore be appreciated that the description of image processing unit 122 is not limited only to those facial recognition algorithms described herein; rather, a variety of suitable facial recognition algorithms are contemplated herein.

Generally, as noted above, the facial recognition algorithm may first determine whether a person is detected within FOV 104. In some implementations, the facial recognition algorithm includes depth-sensing to ensure that a detected person is an actual (e.g., “real-life”) person as opposed to a 2D image (e.g., a photograph). For example, in such implementations, the facial recognition algorithm may account for depth information included in the image data when analyzing the image data to detect faces. In other implementations, image processing unit 122 first detects one or more persons in the image data and then separately executes a depth-sensing algorithm to confirm that any detected persons are real. In some implementations, image processing unit 122 continuously or periodically analyzes image data of FOV 104 (e.g., provided as a video feed or a series of still images) using a depth-sensing facial recognition algorithm to detect when real persons enter FOV 104 (e.g., step in front of user interface 142).

Once at least one real person is detected within FOV 104 (e.g., as part of the facial recognition processing), image processing unit 122 may determine whether the detected person (e.g., user 106) is an authorized user of system 100. For example, as mentioned above, image processing unit 122 may generate a model and/or calculate identifying characteristics of a detected face. Subsequently, the model and/or identifying characteristics can be compared to stored facial models and/or characteristics of previously registered users of system 100. As shown in FIG. 1, facial models and/or characteristics of registered (e.g., authorized) users of system may be stored in a registered users database 128. Accordingly, if a match between the generated model and/or calculated identifying characteristics of the detected person (e.g., user 106) is identified within registered users database 128, then it may be determined that the detected person is an authorized user of system 100.

In some implementations, image processing unit 122 is configured to generate the facial models and/or characteristics stored in registered users database 128 as part of a registration process for new users. For example, users of system 100 may establish a user profile in system 100 and may voluntarily have their face scanned and analyzed by depth-sensing image capture device 102 and image processing unit 122. In some such implementations, multiple images of a new user (e.g., at varying angles, in varying lighting, etc.) are captured and analyzed using the aforementioned depth-sensing facial recognition algorithm to generate a facial model and/or characteristics which are then maintained in registered users database 128 for later comparison/identification.

After image processing unit 122 detects a user and determines that they are an authorized (e.g., registered) user of system 100, a user authenticator 124 may determine and/or generate permissions for the user. “Permissions” within system 100 generally define the content and/or resources of system 100 that are accessible to a user. For example, in a pharmacy setting, a pharmacist and pharmacy technicians may have sufficient permissions to view patient PHI, whereas pharmacy assistants or interns may not. In some implementations, user authenticator 124 determines or generates user permissions based on a user profiled in registered users database 128. For example, after identifying the user using facial recognition, the user's permissions (e.g., which are predefined) may be retrieved from registered users database 128. In some implementations, permissions are generated based on certain parameters of the user's profile. For example, the user's profile may indicate a title or position of the user, which is used to determine the user's permissions. Continuing the previous example, user permissions for a job title of “pharmacist” may be different from those of a “pharmacy assistant.”

In some implementations, user authenticator 124 controls access to system 100, or the resources thereof, based on the determined permissions. For example, user authenticator 124 may adjust permissions within system 100 to suit the identified user, such as by limiting access to particular information or resources. In some implementations, if a person is detected within FOV 104 but they are determined not to be an authorized user of system 100, user authenticator 124 can prevent access to system 100. In some such implementations, user authenticator 124 may lock system 100 or may prevent the user from accessing information and resources within system 100. In some implementations, user authenticator 124 may cause any information displayed by system 100 (e.g., via user interface 142) to be obscured if an unauthorized user is detected. In some implementations, user authenticator 124 is configured to generate records of user interactions and/or access attempts, which are stored in an access log 130. For example, if an unauthorized user is detected and/or attempts to interact with system 100, user authenticator 124 may record details of the interaction (e.g., day and time, what actions the user tried to perform, etc.). Similarly, user authenticator 124 may store records of authorized user interactions, such as for auditing purposes. For example, user authenticator 124 may record a day and time of an authorized user accessing system 100. In some implementations, user authenticator 124 can store an image of any unauthorized users that attempt to interact with system 100.

In some implementations, user authenticator 124 is also configured to maintain user settings and work, for example, when a user steps away from system 100. For example, if a first user steps away from system 100 (e.g., is no longer detected in FOV 104), user authenticator 124 may save the current progress of the user's work (e.g., maintaining open applications, settings, etc.). In some implementations, user authenticator 124 can maintain work/settings for multiple users. For example, if a first user steps away from system 100 and a second user is detected, user authenticator 124 may maintain the first user's work while providing access to the second user. If the second user then steps away from system 100 and the first user returns, user authenticator 124 may reinstate the first user's work and may maintain the second user's work in the background. This allows for quickly switching between users of system 100 using facial recognition, rather than requiring individual users to log in/out using a password, fingerprint, etc.

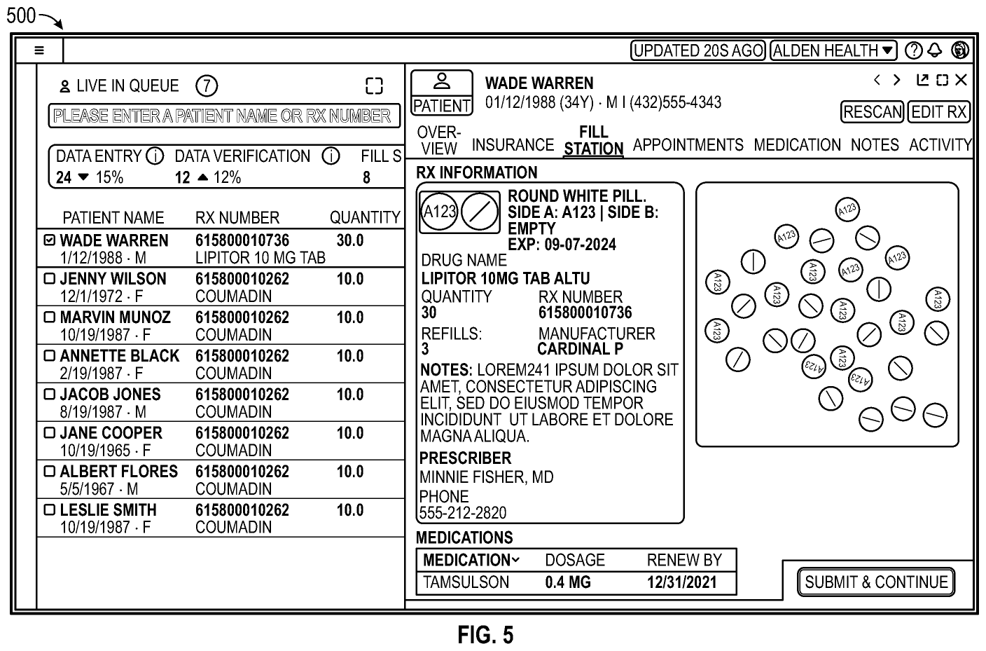

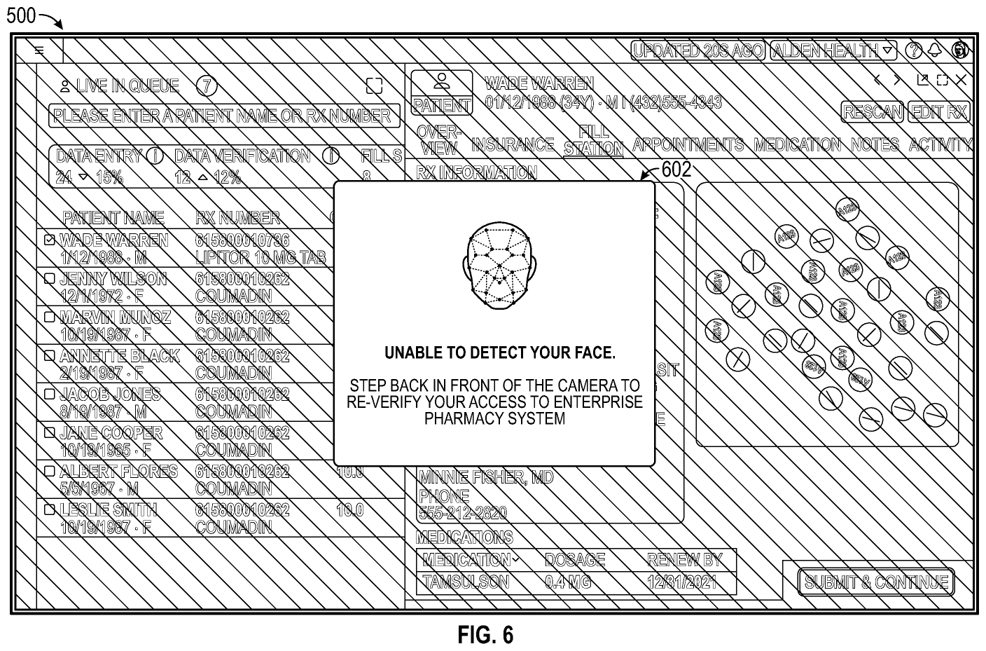

In some implementations, memory 120 includes a user interface (UI) and notification generator 126 that can generate notifications and/or graphical user interfaces (GUIs). In some implementations, UI and notification generator 126 generates GUIs relating to a pharmacy management system implemented by system 100. Example of pharmacy-related GUIs are shown in FIGS. 5 and 6, described below. In some implementations, UI and notification generator 126 generates a notification if an unauthorized user attempts to access system 100. In some such implementations, the notification may be presented via user interface 142. In some implementations, the notification may be transmitted to another computing device, such as a personal computer or smartphone operated by an authorized user of system 100. For example, if an authorized user attempts to access system 100 in a pharmacy, a notification may be transmitted to the lead pharmacist. In some such implementations, the notification may indicate that an unauthorized user is attempting to access system 100 and may even include an image of the person attempting to gain access.

Communications interface 140, as mentioned above, is generally configured to facilitate communications between system and any external components or devices, including depth-sensing image capture device 102. For example, communications interface 140 can provide means for transmitting data to, or receiving data from, depth-sensing image capture device 102 or any other remote device (e.g., another computer). Accordingly, communications interface 140 can be or can include a wired or wireless communications interface (e.g., jacks, antennas, transmitters, receivers, transceivers, wire terminals, etc.) for conducting data communications, or a combination of wired and wireless communication interfaces. In some embodiments, communications via communications interface 140 are direct (e.g., local wired or wireless communications) or via a network (e.g., a WAN, the Internet, a cellular network, etc.). For example, communications interface 140 may include one or more Ethernet ports for communicably coupling system 100 to a network (e.g., the Internet). In another example, communications interface 140 can include a WiFi transceiver for communicating via a wireless communications network. In yet another example, communications interface 140 may include cellular or mobile phone communications transceivers. In yet another example, communications interface 140 includes a universal serial bus (USB) jack and associated hardware for serial communications.

User interface 142, as mentioned numerous times above, generally includes at least a display screen (e.g., an LED or LCD screen) for presenting data (e.g., GUIs) to a user of system 100. For example, user interface 142 may be a monitor that is communicably coupled to system 100 via a suitable connection (e.g., HDMI or Display Port). Generally, user interface 142 is capable of display images, text, and other data. In some implementations, user interface 142 also includes a user input device, such as a mouse, a keyboard, a keypad, a controller, etc. In some implementations, user interface 142 includes an integrated display screen and user input device, such as a touchscreen display. In any case, user interface 142 may be configured to receive user inputs in addition to displaying data.

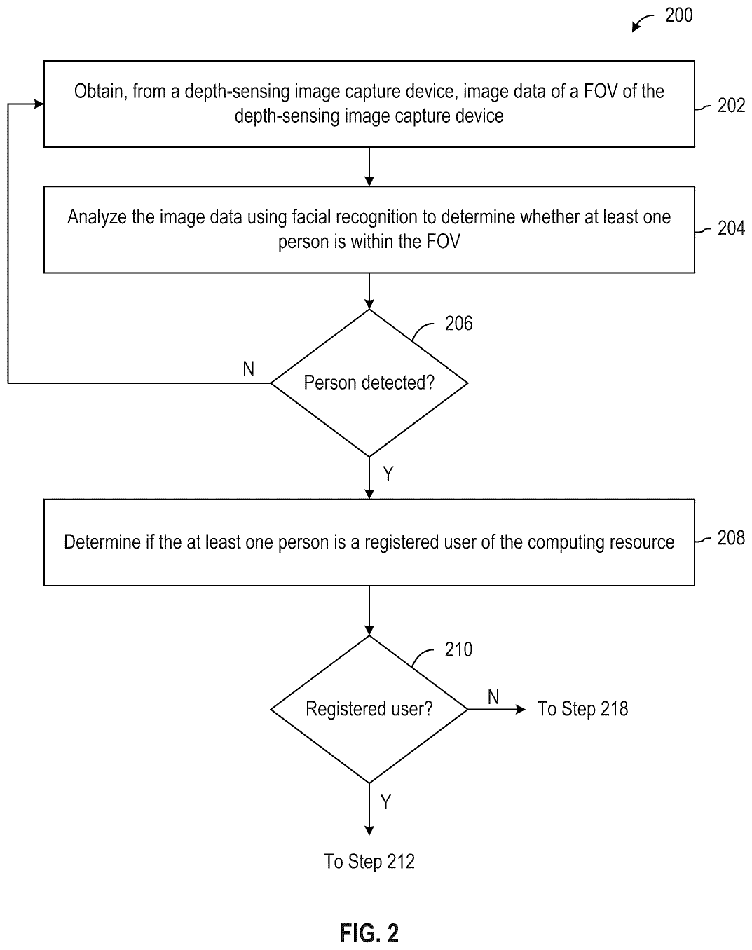

Referring now to FIG. 2, a flow chart of a process 200 for user authentication using depth-sensing facial recognition is shown, according to some implementations. As mentioned above, process 200 generally addresses numerous limitations of common user authentication techniques; namely, continuously or periodically authenticating a user addresses scenarios where a user steps away from a computing device by quickly adjusting permissions, and depth-sensing ensures that a photograph or other 2D image cannot be used to access the computing resource. It should be appreciated that multiple steps of process 200, or process 200 as a whole, can be continuously or periodically repeated. For example, process 200 may be continuously repeated for continuous monitoring/detection of users of system 100.

In some implementations, process 200 is repeated at an interval of five seconds or less; although, any interval is contemplated herein. For example, in some implementations, process 200 is repeated more often than, or less than, every five seconds. Process 200 may be particularly well-suited for protecting sensitive data in a pharmacy setting, where multiple users with different permissions interact with a pharmacy computer. In some implementations, process 200 is implemented by system 100, as described above. It will be appreciated that certain steps of process 200 may be optional and, in some implementations, process 200 may be implemented using less than all of the steps. It will also be appreciated that the order of steps shown in FIG. 2 is not intended to be limiting.

At step 202, image data of a FOV of a depth-sensing image capture device is obtained. As mentioned above, the depth-sensing image capture device (e.g., depth-sensing image capture device 102) described herein is generally one of a stereo vision camera, a ToF camera, a structured light camera, or other suitable depth-sensing camera, which defines a FOV (e.g., FOV 104) that points outwards from a user interface (e.g., user interface 142) of a computing device (e.g., system 100) in order to detect, and capture images of, users of the computing device. For example, the depth-sensing image capture device may be positioned on top of a display (e.g., a monitor) of a computer (e.g., similar to a webcam) such that the depth-sensing image capture device's FOV is directed outward from the display and towards a user. In some implementations, the image(s) of the FOV are received from the depth-sensing image capture device as a video feed (e.g., in real or near-real time). In other implementations, the image(s) of the FOV are received periodically (e.g., every second, multiple times per second) as still images.

Generally, the image data obtained from the depth-sensing image capture device includes at least one “standard” (e.g., in the visible light spectrum) image of the FOV, along with 3D or depth information for any objects within the FOV. For example, the image data may include a depth map of the FOV along with a standard photograph of the FOV. In some implementations, where the depth-sensing image capture device is a stereo vision camera, the image data can include at least two “standard” images of the FOV taken from different angles or perspectives. In other implementations, the image data can include IR image data, LiDAR data, etc. To this point, it should be appreciated that various types of “image data” can be obtained from the depth-sensing image capture device based on the specific type of depth-sensing image capture device used.

At step 204, the image data is analyzed using a facial recognition model to determine whether a person is positioned in the FOV. In other words, the image data is provided as an input to a facial recognition model in order to detect persons within the FOV. For example, the facial recognition model may output an indication of whether or not a person is detected in the image(s) and may also indicate where, in the image(s), the person is positioned. Generally, any suitable facial recognition model can be used, such as a CNN, eigenfaces, fisherfaces, PCA, SVM, and the like. In some implementations, the facial recognition model is configured to process depth information, in addition to standard image data, in order to detect persons in the FOV. In other implementations, a separate depth-sensing algorithm is used to process depth information contained within the image data, and the depth-sensing analysis is combined with standard facial recognition in order to detect persons. For example, a facial recognition model may be used to detect faces within the captured image(s) and, if at least one face is detected, the depth information contained within the image data may be evaluated to verify that the detected face is, in fact, a real (e.g., 3D) face, as opposed to a photograph or other 2D image.

At step 206, if a person is not detected within the FOV, the process 200 may revert back to step 202. In this regard, steps 202 and 204 of process 200 are continuously or periodically repeated until a person is detected. For example, depth-sensing image capture device can continuously capture image data of the FOV and evaluate the image data using a facial recognition model to detect persons that are in the FOV (e.g., “monitor” the FOV to detect persons). However, if a person is detected within the FOV of the depth-sensing image capture device, then process 200 may continue to step 208.

In some implementations, a further determination is first made as to whether the detected person is interacting with the computing resource before process 200 continues to step 208. For example, the image data may simply be evaluated to determine whether any detected person(s) are within a threshold distance from the depth-sensing image capture device. In this way, persons that are too far away from the depth-sensing image capture device to be operating the associated computing resource may can be ignored. In another example, step 206 can include determining whether the person is physically interacting with the computing resource, such as by interacting with a user input device (e.g., touching a keyboard, moving a mouse, etc.), which is used to inform a decision as to whether the person that is detected using the image data is a user of the computing resource.

At step 208, if a person is detected within the FOV—and it is therefore assumed or determined that the person is interacting with, or attempting to interact with, the associated computing resource—then the facial recognition model may be further used to determine whether the detected person is a registered user of the computing resource. In some implementations, after detecting a face and confirming that the detected face belongs to a real person (e.g., detecting a facial using depth-sensing), the facial recognition model compares the detected face to a database of registered users of the computing resource to identify a match. In some such implementations, the facial recognition model compares characteristics of the detected face to stored characteristics of the faces of registered users. In some implementations, the facial recognition model is executed on a database containing images of registered users to either generate facial characteristic data or to directly match the detected face with a known registered user.

If it is determined that the detected face belongs to a registered user of the computing resource, the process 200 may continue to step 212. Otherwise, if a person is detected but they are determined not to be a registered user of the computing resource, process 200 may continue to step 218. It should be appreciated that, while steps 204 through 210 of process 200 are described separately herein for clarity, in some implementations, these steps are completed concurrently. For example, a single facial recognition model may be used to evaluate image data obtained from a depth-sensing image capture device to simultaneously determine whether any persons are detected within a FOV and whether any detected persons are registered users of the computing resource.

At step 212, if the detected person is determined to be a registered (e.g., authorized) user of the computing resource, then permissions are determined for the authorized user. As noted above, user permissions generally define the content and/or resources of a computing resource that the user can access. For example, user permissions may define the content (e.g., patient information, file types, etc.) that the user can access, may dictate whether a user can edit or just view content, etc. In a pharmacy setting, user permissions may dictate whether a user can view patient PII or PHI, for example. In some implementations, user permissions are predefined and may therefore simply be retrieved once the user is identified. For example, user permissions may be defined in a user profile for the user. In some implementations, user permissions are defined based on aspects of a user's profile, such as a job title, security clearance, etc. For example, the user's profile may indicate the user's job title (e.g., pharmacist) which is used to determine the user's permissions. In some such implementations, user permissions are generated based on the user's profile.

At step 214, access to the computing resource is provided based on the determined or generated user permissions. “Providing access” to the computing resource can include, for example, unlocking the computing resource for use. In some implementations, certain functionality or content of the computing resource is limited based on the user's permissions. With respect to a pharmacy computer system, for example, the user may be granted access to view information about a pharmaceutical and/or to enter health insurance information for a patient but may not have access to PHI. At step 216, details of the interaction are logged (e.g., used to create a record in a database). For brevity, details of step 216 are described below with respect to step 222, as these steps are broadly the same.

At step 218, if it is determined that a person is detected within the FOV (e.g., within the image data provided by the depth-sensing image capture device) but that the detected person is not an authorized user of the computing resource, then access to the computing resource is limited. In particular, the computing resource may be locked to prevent unauthorized access. “Locking” the computing resource can include, for example, preventing access to various content, preventing the computing resource from displaying information, preventing use of the computing resource as a whole, etc. Generally, limiting access to the computing resource includes, at least, obscuring data presented on a user interface. Obscuring the data can include preventing the data from being displayed, modifying a visual appearance of the data so that it is not visible or readable, etc. An example of obscuring the data displayed by a user interface of the computing resource when a user is not detected is shown in FIG. 6, described below, which shows information being obscured using a blurring effect.

At step 220, a notification is optionally generated and/or displayed which indicates that the detected person is not authorized to access the computing resource. In some implementations, the notification is an alert that is displayed on the user interface of the computing resource. For example, the notification may indicate “Unauthorized User Detected” or “System Locked to Prevent Unauthorized Access”. In some implementations, the notification may indicate that the face of an authorized user is not detected. In some implementations, the notification may be transmitted to a remote device. For example, in a pharmacy, a notification may be sent to a device operated by a lead pharmacists or pharmacy manager indicating that an unauthorized user was detected and/or is attempting to access the computer system. In some such implementations, the notification can provide information to the recipient such as the time unauthorized access was detected, an image of the person that was detected, etc.

At step 222, which may be the same as step 216, details of the interaction are logged. In other words, a record may be created of the authorized or unauthorized user's interaction with the computing resource, which allows for later review and auditing of security measures. Details of the interaction can include, for example, a date and/or time that the user was detected and/or accessed the computing resource, what actions the user took when they had access to the computing resource, and the like. In some implementations, an image of each user that accesses system 100 is captured and stored.

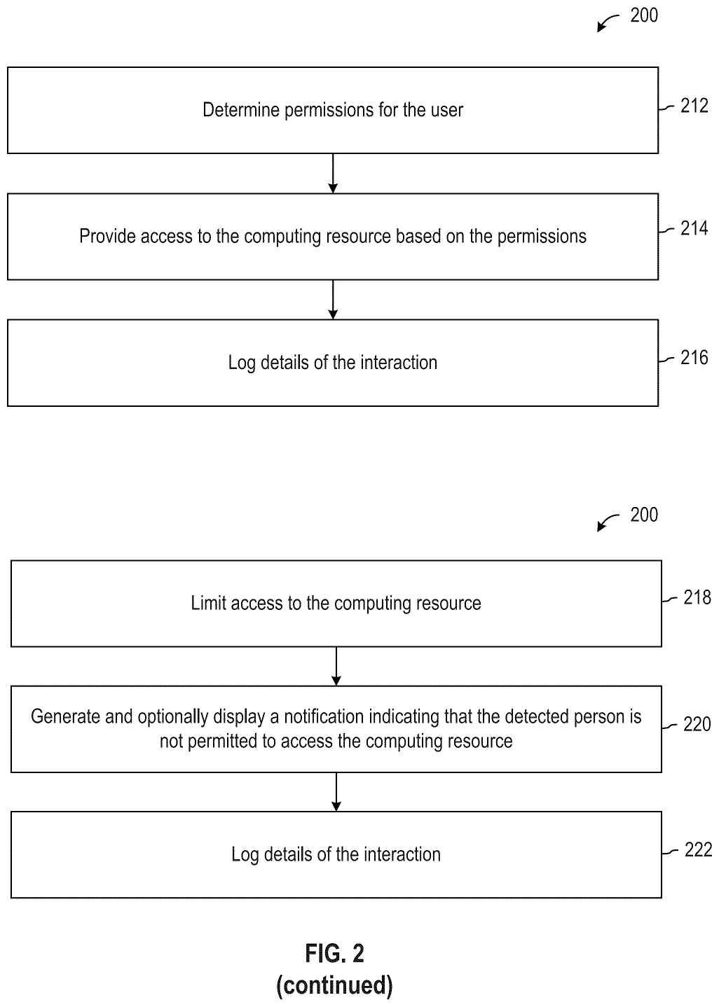

Referring now to FIG. 3, a flow chart of a process 300 for modifying user permissions in a computer system if one or more additional persons are detected within a FOV of a depth-sensing image capture device is shown, according to some implementations. Specifically, process 300 can help to ensure that unauthorized users are not able to view sensitive data by, for example, standing behind an authorized user. In some implementations, process 300 is implemented by system 100, as described above. It should be appreciated that, in some implementations, process 300 is implemented concurrently with process 200, or as a portion of process 200. It will be appreciated that certain steps of process 300 may be optional and, in some implementations, process 300 may be implemented using less than all of the steps. It will also be appreciated that the order of steps shown in FIG. 3 is not intended to be limiting.

At step 302, at least one person—other than a user of a computing resource—is detected within the FOV of a depth-sensing image capture device. To prevent sensitive information from being viewed by unauthorized persons, image data obtained from the depth-sensing image capture device is monitored, even as an authorized user is operating or interacting with an associated computing resource, to determine whether any additional persons are attempting to view data presented on a user interface of the computing resource. For example, an unauthorized user could attempt to view sensitive information by standing behind the authorized user but within eyesight of the user interface.

In some implementations, image data obtained from the depth-sensing image capture device is continuously or periodically evaluated using a facial recognition model, as described above with respect to steps 202-206, in order to detect multiple users within the depth-sensing image capture device's FOV. For example, a live (e.g., video) feed from the depth-sensing image capture device can be monitored to detect if a second person steps into the FOV. In some implementations, the determination that at least one additional person is detected within the FOV is made during a repetition of process 200, described above. In some implementations, the facial recognition model can further be used to determine whether any persons detected in the background of the FOV are positioned towards (e.g., facing) the user interface, to prevent false positives from person(s) that are simply standing behind a user of the computing resource and/or passing by.

At step 304, it is determined whether the additional detected person is a registered user of the computing resource. Specifically, if at least one additional person is detected within the FOV, and optionally is determined to be facing the user interface of the computing resource, step 208 of process 200 can be performed to compare the face of the detected person against a database of authorized users. Based on the comparison, it can be determined whether the detected additional detected person is an authorized user of the computing resource.

At step 306, user permissions within the computing resource are modified based on the user permissions of the additional detected person. Specifically, steps 212-216 of process 200 can be performed if the additional detected person is determined to be an authorized user, whereas steps 218-222 of process 200 are performed if the additional detected person is not an authorized user. In some implementations, the computing resource is locked if an unauthorized person is detected. In some implementations, information displayed on the user interface of the computing resource is obscured (e.g., blurred) if an unauthorized person is detected. In some implementations, the authorized user of the computing resource is prevented from accessing sensitive data if an unauthorized person is detected. In some implementations, a notification is displayed on the user interface (e.g., to the authorized user) indicating that an unauthorized user is detected in the background of the FOV.

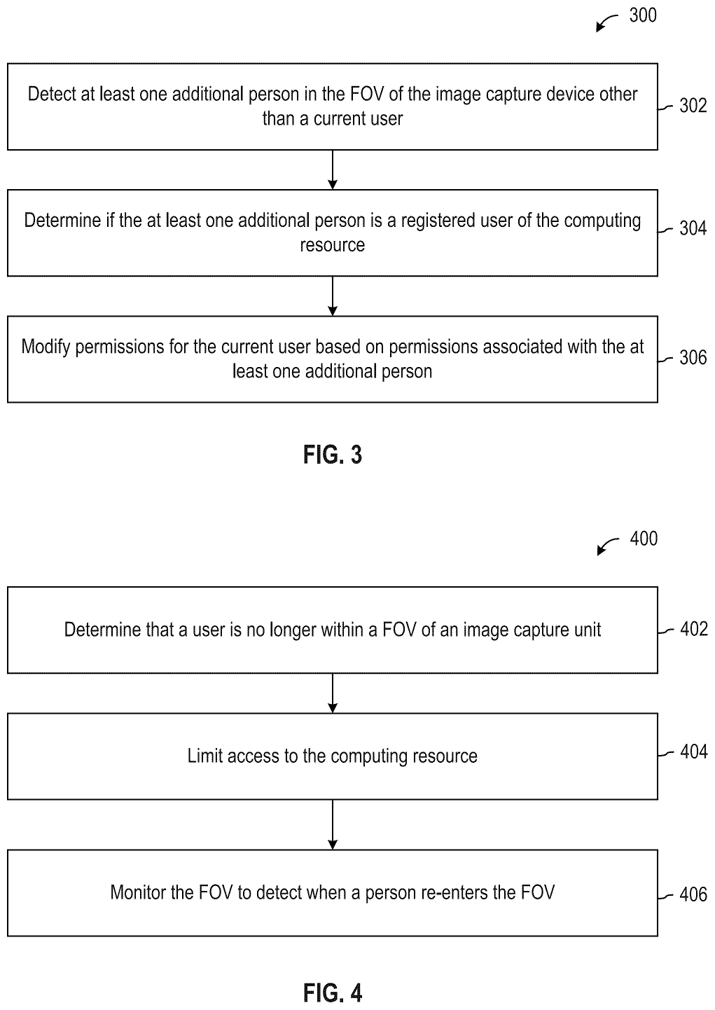

Referring now to FIG. 4, a flow chart of a process 400 for modifying user permissions in a computer system if it is determined that the user has stepped away from the computer system is shown, according to some implementations. As discussed above, process 400 may be useful in dynamic settings where users of a computing resource regularly step away from the computing resource and/or leave the computing resource unattended. Process 400 can help to ensure that sensitive data is not accessible to an unauthorized user if the authorized user steps away. For example, in a pharmacy, a first user may step away from a pharmacy computer to assist a customer; thus, process 400 helps to ensure that an unauthorized user cannot attempt to use the pharmacy computer to view sensitive information when the first user steps away. In addition, process 400 allows for rapidly switching between user permissions while maintaining underlying work, such that multiple users can use the same computing resource (e.g., the same computer) without requiring each user to log in/out.

In some implementations, process 400 is implemented by system 100, as described above. It should be appreciated that, in some implementations, process 400 is implemented concurrently with process 200, or as a portion of process 200. Similarly, process 400 may be implemented concurrently with, or as a part of, process 300. It will be appreciated that certain steps of process 400 may be optional and, in some implementations, process 400 may be implemented using less than all of the steps. It will also be appreciated that the order of steps shown in FIG. 4 is not intended to be limiting.

At step 402, a determinization is made that a user (e.g., of a computing resource) is no longer within a FOV of a depth-sensing image capture unit. In other words, it is detected that the user of the computing resource has stepped away (e.g., from the user interface) and/or is no longer using the computing resource. In some implementations, this determination that is made during a repetition of process 200, described above. For example, during at least one repetition of process 200, it may be determined that a previously detected user is no longer present. In some implementations, image data obtained from the depth-sensing image capture device is continuously or periodically (e.g., every few seconds) evaluated using a facial recognition model, as described above with respect to steps 202-206, in order to make the determination that the user has stepped away.

At step 404, if it is determined that the user of the computing resource has stepped away (e.g., in no longer detected), then access to the computing resource is limited. In some implementations, this includes locking the computer resource to prevent access. In some implementations, limiting access to the computing resource includes obscuring data displayed on the user interface of the computing resource, as shown in FIG. 6. In some implementations, functionality of the computing resource is severely limited (e.g., to only basic functions). It is important to note, however, that the underlying work of the user of the computing resource is generally preserved even if the user is no longer detected (e.g., if the user steps away). For example, the user's work and/or settings may be maintained as a background process for at least a predetermined amount of time.

At step 406, the FOV is monitored to detect if the user re-enters the FOV. In other words, image data from the depth-sensing image capture device is continuously or periodically evaluated (e.g., as in steps 202-208 of process 200) to determine whether the user is detected. If the user is determined to have re-entered the FOV (e.g., the user stepped away from, and then back to, the computing resource), the user's underlying work may be reinstated. For example, the computing resource may lock if the user steps out of the detection zone of the depth-sensing image capture device and may unlock if the user is re-detected. In some implementations, if the user is not detected within a predetermined amount of time, the user's underlying work, which was being maintained, may be released. In some implementations, if a new user is detected (e.g., using process 200), then the first user's underlying work is preserved for the predetermined amount of time (e.g., a day) and the new user is provided access to the computing resource based on their respective user permissions. For example, the new user may be verified (e.g., using process 200) and granted access to start their own session in the computing resource.

Referring now to FIGS. 5 and 6, an example user interface 500 for a pharmacy management system is shown, according to some implementations. Generally, user interface 500 is an example of the type of user interface that can be displayed by system 100, as described above. For example, system 100 can be a computer (e.g., a workstation) in a pharmacy that runs pharmacy management software which generates and displays user interface 500. As shown, user interface 500 includes a “live” or active queue of pharmacy tasks—in this case, prescriptions to be filed—which indicate a patient name, prescription number, quantity, and other information (e.g., patient identifiers, medication name, etc.). It should be appreciated that the queue panel shown in user interface 500 may also display other information.

In this example, a pharmacy user has selected a prescription for a first patient, which populates a window displaying patient information, prescription information, etc. In some implementations, this window is displayed responsive to the user selecting a patient or prescription and can be a separate interface, a popup or overlay, etc. Here, the pharmacy user has navigated to a “fill station” tab for filling the prescription, which displays information about the medication being dispensed, such as the medication name, identifying information, an image of the medication, the prescription number and quantity, prescribing professional identification, etc. Accordingly, it could be assumed that the current user of the pharmacy management system is a pharmacist or pharmacy technician that has sufficient permissions to view prescription information and fill prescriptions.

Using system 100 and the various processes described above (e.g., processes 200, 300, and 400), user interface 500 may be displayed as long as the current user is standing in front of and/or interacting with system 100. If, however, the current user steps away from system 100—or, more specifically, out of the FOV of depth-sensing image capture device 102—access to the pharmacy management system may be limited as shown in FIG. 6. In this case, a notification 602 is displayed indicating to the user that a face is not detected. Notification 602 may prompt the user to “step back in front of the camera to re-verify your access to [the system]”.

Additionally, the information displayed in user interface 500 is obscured if the user is not detected. As shown, obscuring the information can include adding a blurring effect such that text is not readable and/or images cannot be clearly defined, but it should be appreciated that user interface 500 may be visually modified in any other manner to obscure the information. In other implementations, system 100 is locked such that user interface 500 is completely hidden or replaced with another interface. In some implementations, notification 602 is also displayed to indicate to a user that a second, unauthorized person is detected within the FOV and/or is suspected of viewing information from the display of system 100. If the pharmacy user subsequently steps back into view of the camera, as prompted by notification 602, user interface 500 may be re-displayed. In other words, the obscuring of the displayed information may be reversed or removed. In some implementations, system 100 is unlocked responsive to the re-detection of the user's face.

If, however, a different user is detected (e.g., a pharmacy technician steps away from the computer and a pharmacy intern begins using the computer), then the underlying work of the first user is preserved, at least for a predetermined amount of time (e.g., 24 hours). Preserving the first user's work may include saving settings and data, maintaining processes or applications in the background, etc., such that the first user's work can be restored if the first user is re-detected. Additionally, when a second, different user is detected, and verified as an authorized user of the system, the second user may be provided access to the system in accordance with their permissions.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc., of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A method of user authentication for a computer system, the method comprising continuously or periodically:
obtaining at least one image of a field-of-view (FOV) of a depth-sensing image capture device, wherein the FOV is directed outward from a user interface of the computer system;
analyzing the at least one image using a facial recognition model with depth-sensing to:
i) determine whether a person is positioned within the FOV, and
ii) if it is determined that a person is positioned within the FOV, determine whether the person is a registered user of the computer system;
if it is determined that the person is a registered user of the computer system, then:
determining permissions within the computer system for the person based on a user profile for the person, wherein the permissions define content that can be displayed via the user interface of the computer system; and
providing access to the computing system in accordance with the determined permissions.

2. The method of claim 1, wherein access to the computer system is limited, or the computer system is locked, if it is determined that either: i) a person is not detected within the FOV, or ii) the person positioned within the FOV is not a registered user of the computer system.

3. The method of claim 2, wherein limiting access to, or locking, the computer system comprises obscuring data on the user interface.

4. The method of claim 2, further comprising generating an alert if it is determined that the person positioned within the FOV is not a registered user of the computer system, wherein the alert is displayed via the user interface and/or transmitted to a remote device.

5. The method of claim 1, further comprising:
detecting, during at least one repetition of the method, using the facial recognition model with depth-sensing, that at least one additional person is positioned within the FOV of the depth-sensing image capture device and is facing the user interface;
determining whether the at least one additional person is a registered user of the computer system;
if it is determined that the person is a registered user of the computer system, then determining permissions within the computer system for the at least one additional person; and
modifying access to the computing system in accordance with the determined permissions of the at least one additional person.

6. The method of claim 1, further comprising:
determining, during at least one repetition of the method, using the facial recognition model with depth-sensing, that the person is no longer positioned within the FOV or is no longer facing the user interface; and
limiting access to, or locking, the computer system.

7. The method of claim 1, wherein the depth-sensing image capture device is one of a stereoscopic camera, a time-of-flight camera, or a structured light camera.

8. The method of claim 1, wherein the at least one image is obtained from a video feed provided by the depth-sensing image capture device.

9. The method of claim 1, wherein the method is periodically repeated at an interval of five seconds or less.

10. A non-transitory computer readable medium having instructions stored thereon that, when executed by at least one processor, cause a computing device to continuously or periodically:
obtain at least one image of a field-of-view (FOV) of a depth-sensing image capture device, wherein the FOV is directed outward from a user interface of the computing device;
analyze the at least one image using a facial recognition model to:
i) determine whether a person is positioned within the FOV, and
ii) if it is determined that a person is positioned within the FOV, determine whether the person is a registered user of the computing device;
if it is determined that the person is a registered user of the computing device, then:
determine permissions within the computing device for the person based on a user profile for the person, wherein the permissions define content that can be displayed via the user interface of the computing device; and
provide access to the computing device in accordance with the determined permissions.

11. The computer readable medium of claim 10, wherein access to the computing device is limited, or the computing device is locked, if it is determined that either: i) a person is not detected within the FOV, or ii) the person positioned within the FOV is not a registered user of the computer system.

12. The computer readable medium of claim 11, wherein limiting access to, or locking, the computing device comprises obscuring data on the user interface.

13. The computer readable medium of claim 11, wherein the instructions further cause the computing device to:
generate an alert if it is determined that the person positioned within the FOV is not a registered user of the computing device, wherein the alert is displayed via the user interface and/or transmitted to a remote device.

14. The computer readable medium of claim 10, wherein the instructions further cause the computing device to:
detect, during at least one repetition of the method, using the facial recognition model with depth-sensing, that at least one additional person is positioned within the FOV of the depth-sensing image capture device and is facing the user interface;
determine whether the at least one additional person is a registered user of the computing device;
if it is determined that the person is a registered user of the computing device, then determine permissions within the computing device for the at least one additional person; and
modify access to the computing device in accordance with the determined permissions of the at least one additional person.

15. The computer readable medium of claim 10, wherein the instructions further cause the computing device to:
determine, during at least one repetition of the method, using the facial recognition model with depth-sensing, that the person is no longer positioned within the FOV or is no longer facing the user interface; and
limit access to, or lock, the computer device.

16. The computer readable medium of claim 10, wherein the depth-sensing image capture device is one of a stereoscopic camera, a time-of-flight camera, or a structured light camera.

17. The computer readable medium of claim 10, wherein the at least one image is obtained from a video feed provided by the depth-sensing image capture device.

18. A pharmacy computer system comprising:
a processor; and
memory having instructions stored thereon that, when executed by the processor, cause the pharmacy computer system to continuously or periodically:
obtain at least one image of a field-of-view (FOV) of a depth-sensing image capture device, wherein the FOV is directed outward from a user interface of the pharmacy computer system;
analyze the at least one image using a facial recognition model to:
i) determine whether a person is positioned within the FOV, and
ii) if it is determined that a person is positioned within the FOV, determine whether the person is a registered user of the pharmacy computer system;
if it is determined that the person is a registered user of the pharmacy computer system, then:
determine permissions within the pharmacy computer system for the person based on a user profile for the person, wherein the permissions define content that can be displayed via the user interface; and
provide access to the pharmacy computing system in accordance with the determined permissions.

19. The pharmacy computer system of claim 18, wherein access to the pharmacy computer system is limited, or the pharmacy computer system is locked, if it is determined that either: i) a person is not detected within the FOV, or ii) the person positioned within the FOV is not a registered user of the computer system.

20. The pharmacy computer system of claim 18, wherein the instructions further cause the pharmacy computer system to:
determine, during at least one repetition of the method, using the facial recognition model with depth-sensing, that the person is no longer positioned within the FOV or is no longer facing the user interface; and
limit or prevent access to the pharmacy computer system.
